(19) United States
(12) Patent Application Publication
(10) Pub. No.: US 2013/0081382 A1
(43) Pub. Date: Apr. 4, 2013

(54) REGENERATION CONFIGURATION FOR CLOSED-LOOP HYDRAULIC SYSTEMS

(71) Applicants: Bryan E. NELSON, Lacon, IL (US); Michael L. KNUSSMAN, East Peoria, IL (US); Brad A. EDLER, Waterloo, IL (US)

(72) Inventors: Bryan E. NELSON, Lacon, IL (US); Michael L. KNUSSMAN, East Peoria, IL (US); Brad A. EDLER, Waterloo, IL (US)

(21) Appl. No.: 13/249,932

(22) Filed: Sep. 30, 2011

(51) Int. Cl. F16D 31/02

(52) U.S. Cl. 60/327; 60/459

(57) ABSTRACT

A hydraulic system is disclosed. The hydraulic system may have a pump, and a hydraulic actuator having a first chamber and a second chamber. The hydraulic system may also have a first pump passage fluidly communicating the pump with the first chamber, a second pump passage connected to the pump, and a regeneration valve. The regeneration valve may be movable from a first position at which the second pump passage is connected to the second chamber and the second chamber is isolated from the first chamber, to a second position at which the second pump passage is blocked and the second chamber is connected to the first chamber.

### TECHNICAL FIELD

The present disclosure relates generally to a hydraulic system and, more particularly, to a regeneration configuration for closed-loop hydraulic systems.

### BACKGROUND

Machines such as excavators, dozers, loaders, motor graders, and other types of heavy equipment use one or more hydraulic actuators to move a work tool. These actuators are fluidly connected to a pump on the machine that provides pressurized fluid to chambers within the actuators. As the pressurized fluid moves into or through the chambers, the pressure of the fluid acts on hydraulic surfaces of the chambers to affect movement of the actuator and the connected work tool. In an open-loop hydraulic system, fluid discharged from the actuator is directed into a low-pressure sump, from which the pump draws fluid. In a closed-loop hydraulic system, fluid discharged from the actuator is directed back into the pump and immediately recirculated.

Regeneration within an open-loop system may help to increase the efficiency of the system. Regeneration during extension of a hydraulic cylinder is typically accomplished by connecting a rod-end chamber of a hydraulic actuator directly with a head-end chamber of the same actuator, while also supplying fluid from the pump to the head-end chamber. As the pressure within both chambers during regeneration may be about equal, the hydraulic cylinder will extend due to an imbalance of forces created by the pressure acting on disproportionate areas within the two chambers. Because the head-end of the hydraulic cylinder is being supplied with fluid both from the pump and from the rod-end chamber during extension regeneration, the hydraulic cylinder may be able to move faster and/or have fewer losses than otherwise possible.

Regeneration within a closed-loop system has historically not been as effective as within the open-loop system described above. In particular, when the rod-end of a hydraulic cylinder is directly connected to the head-end of the same cylinder, the closed-loop system may be pressure-limited by associated charge relief valves that are generally required within a closed-loop system. Although high-pressures may not be necessary during regeneration, an open-loop system operating at higher pressures will generally outperform a closed-loop system operating at lower pressures.

An exemplary closed-loop system having enhanced regeneration is disclosed in Japanese Patent 2011/069432 of Takashi et al. that published on Apr. 7, 2011 (the '432 patent). The '432 patent describes an over-center, variable displacement pump connected to a hydraulic cylinder. During normal operation, the pump is connected to the hydraulic cylinder in closed-loop manner. However, during regeneration, the pump is connected to only one chamber of the hydraulic cylinder in an open-loop manner. An accumulator is utilized to selectively store high-pressure fluid discharged from the hydraulic cylinder during regeneration and to selectively supply fluid to the pump during normal operation. A charge circuit provides makeup fluid to the pump during open-loop operation.

Although an improvement over conventional hydraulic systems that have a permanent closed-loop configuration, the system of the '432 patent described above may still be less than optimal. In particular, the system of the '432 patent may be overly complex, expensive, and difficult to control. For example, the system of the '432 patent may include a great number of different types of valves that control complicated fluid flows throughout the system. These valves, along with the associated fluid flows, increase an overall cost of the system, while simultaneously increasing computing and control requirements.

The hydraulic system of the present disclosure is directed toward solving one or more of the problems set forth above and/or other problems of the prior art.

### SUMMARY

In one aspect, the present disclosure is directed to a hydraulic system. The hydraulic system may include a pump, and a hydraulic actuator having a first chamber and a second chamber. The hydraulic system may also include a first pump passage fluidly communicating the pump with the first chamber, a second pump passage connected to the pump, and a regeneration valve. The regeneration valve may be movable from a first position at which the second pump passage is connected to the second chamber and the second chamber is isolated from the first chamber, to a second position at which the second pump passage is blocked and the second chamber is connected to the first chamber.

In another aspect, the present disclosure is directed to a method of operating a hydraulic system. The method may include pressurizing fluid with a pump, and maintaining fluid communicating between the pump and a head-end chamber of a hydraulic cylinder. The method may also include selectively fluidly communicating the pump with a rod-end chamber of the hydraulic cylinder during retraction of the hydraulic cylinder and isolating the pump from the rod-end chamber via a regeneration valve during extension of the hydraulic cylinder. The method may further include fluidly connecting the rod-end chamber to the head-end chamber via the regeneration valve when the pump is isolated from the rod-end chamber of the hydraulic cylinder.

### BRIEF DESCRIPTION OF THE DRAWINGS

FIG. 1 is a pictorial illustration of an exemplary disclosed machine;

FIG. 2 is a schematic illustration of an exemplary disclosed hydraulic system that may be used in conjunction with the machine of FIG. 1; and

FIG. 3 is a schematic illustration of another exemplary disclosed hydraulic system that may be used in conjunction with the machine of FIG. 1.

### DETAILED DESCRIPTION

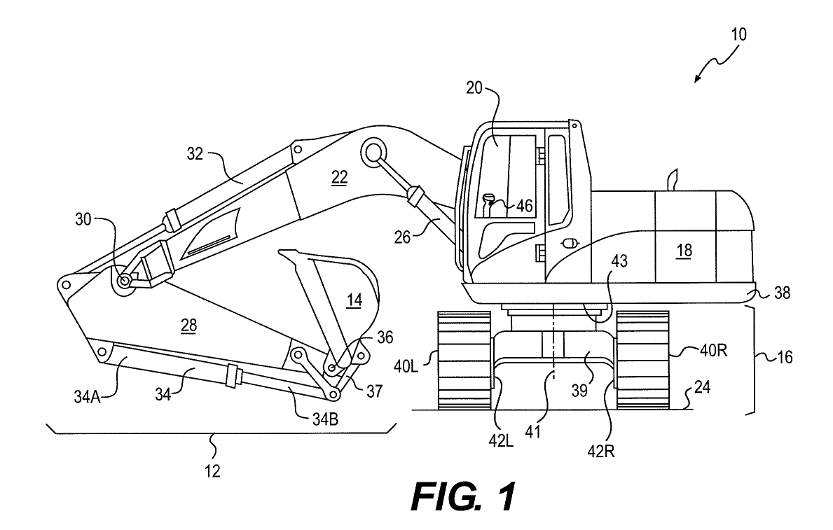

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be an earth moving machine such as an excavator (shown in FIG. 1), a dozer, a loader, a backhoe, a motor grader, a dump truck, or another earth moving machine. Machine 10 may include an implement system 12 configured to move a work tool 14, a drive system 16 for propelling machine 10, a power source 18 that provides power to implement system 12 and drive system 16, and an operator station 20 situated for manual control of implement system 12, drive system 16, and/or power source 18.

Implement system 12 may include a linkage structure acted on by linear and rotary fluid actuators to move work tool 14. For example, implement system 12 may include a boom 22 that is vertically pivotal about a horizontal axis (not shown) relative to a work surface 24 by a pair of adjacent, double-acting, hydraulic cylinders 26 (only one shown in FIG. 1). Implement system 12 may also include a stick 28 that is vertically pivotal about a horizontal axis 30 by a single, double-acting, hydraulic cylinder 32. Implement system 12 may further include a single, double-acting, hydraulic cylinder 34 that is operatively connected between stick 28 and work tool 14 to pivot work tool 14 vertically about a horizontal pivot axis 36. In the disclosed embodiment, hydraulic cylinder 34 is connected at a head-end 34A to a portion of stick 28 and at an opposing rod-end 34B to work tool 14 by way of a power link 37. Boom 22 may be pivotally connected at a base end to a body 38 of machine 10. Body 38 may be connected to an undercarriage 39 to swing about a vertical axis 41 by a hydraulic swing motor 43. Stick 28 may pivotally connect a distal end of boom 22 to work tool 14 by way of axes 30 and 36.

Numerous different work tools 14 may be attachable to a single machine 10 and operator controllable. Work tool 14 may include any device used to perform a particular task such as, for example, a bucket (shown in FIG. 1), a fork arrangement, a blade, a shovel, a ripper, a dump bed, a broom, a snow blower, a propelling device, a cutting device, a grasping device, or any other task-performing device known in the art. Although connected in the embodiment of FIG. 1 to pivot in the vertical direction relative to body 38 of machine 10 and to swing in the horizontal direction about pivot axis 41, work tool 14 may alternatively or additionally rotate relative to stick 28, slide, open and close, or move in any other manner known in the art.

Drive system 16 may include one or more traction devices powered to propel machine 10. In the disclosed example, drive system 16 includes a left track 40L located on one side of machine 10, and a right track 40R located on an opposing side of machine 10. Left track 40L may be driven by a left travel motor 42L, while right track 40R may be driven by a right travel motor 42R. It is contemplated that drive system 16 could alternatively include traction devices other than tracks, such as wheels, belts, or other known traction devices. Machine 10 may be steered by generating a speed and/or rotational direction difference between left and right travel motors 42L, 42R, while straight travel may be facilitated by generating substantially equal output speeds and rotational directions of left and right travel motors 42L, 42R.

Power source 18 may embody an engine such as, for example, a diesel engine, a gasoline engine, a gaseous fuel-powered engine, or another type of combustion engine known in the art. It is contemplated that power source 18 may alternatively embody a non-combustion source of power such as a fuel cell, a power storage device, or another source known in the art. Power source 18 may produce a mechanical or electrical power output that may then be converted to hydraulic power for moving the linear and rotary actuators of implement system 12.

Operator station 20 may include devices that receive input from a machine operator indicative of desired maneuvering. Specifically, operator station 20 may include one or more operator interface devices 46, for example a joystick (shown in FIG. 1), a steering wheel, or a pedal, that are located proximate an operator seat (not shown). Operator interface devices 46 may initiate movement of machine 10, for example travel and/or tool movement, by producing displacement signals that are indicative of desired machine maneuvering. As an operator moves interface device 46, the operator may affect a corresponding machine movement in a desired direction, with a desired speed, and/or with a desired force.

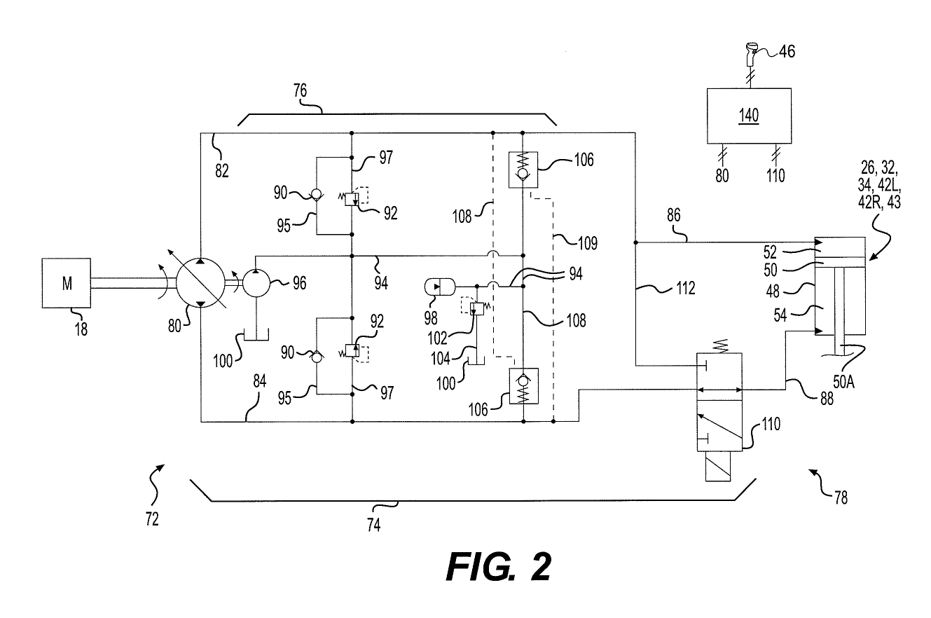

An exemplary hydraulic actuator is shown in the schematic of FIG. 2. It should be noted that, while only a single actuator is shown, the depicted actuator may represent any one or more of the linear actuators (e.g., hydraulic cylinders 26, 32, 34) or the rotary actuators (left travel, right travel, or swing motors 42L, 42R, 43) of machine 10.

The hydraulic actuator, if embodied as a linear actuator may include a tube 48 and a piston assembly 50 arranged within tube 48 to form a first chamber 52 and an opposing second chamber 54. In one example, a rod portion 50A of piston assembly 50 may extend through an end of second chamber 54. As such, each second chamber 54 may be considered the rod-end chamber of the respective actuator, while each first chamber 52 may be considered the head-end chamber. First and second chambers 52, 54 of the hydraulic actuator may be selectively supplied with pressurized fluid from a pump 80 and drained of the pressurized fluid to cause piston assembly 50 to displace within tube 48, thereby changing the effective length of the actuator to move work tool 14. A flow rate of fluid into and out of first and second chambers 52, 54 may relate to a translational velocity of the actuator, while a pressure differential between first and second chambers 52, 54 may relate to a force imparted by the actuator on work tool 14.

The hydraulic actuator, if embodied as a rotary actuator, may function in a similar manner. That is, the rotary actuator may also include first and second chambers located to either side of a pumping mechanism such as an impeller, plunger, or series of pistons. When the first chamber is filled with pressurized fluid from pump 80 and the second chamber is simultaneously drained of fluid, the pumping mechanism may be urged to rotate in a first direction by a pressure differential across the pumping mechanism. Conversely, when the first chamber is drained of fluid and the second chamber is simultaneously filled with pressurized fluid, the pumping mechanism may be urged to rotate in an opposite direction by the pressure differential. The flow rate of fluid into and out of the first and second chambers may determine a rotational velocity of the actuator, while a magnitude of the pressure differential across the pumping mechanism may determine an output torque. The rotary actuator(s) could be fixed- or variable-displacement type motors, as desired.

Machine 10 may include a hydraulic system 72 having a plurality of fluid components that cooperate with the hydraulic actuator to move work tool 14 and machine 10. In particular, hydraulic system 72 may include, among other things, a primary circuit 74 fluidly connecting pump 80 with the hydraulic actuator of machine 10, a charge circuit 76 configured to provide makeup and relief functionality to primary circuit 74, and a regeneration configuration 78 associated with the hydraulic actuator. It is contemplated that hydraulic system 72 may include additional and/or different circuits or components, if desired, such as switching valves, pressure-compensating valves, flow-combining and/or sharing circuits, and other circuits or valves known in the art.

Primary circuit 74 may include multiple different passages that fluidly connect pump 80 to the hydraulic actuator and, in some configurations, to the other actuators of machine 10 in a parallel, closed-loop manner. For example, pump 80 may be connected to the hydraulic actuator via a first pump passage 82, a second pump passage 84, a head-end passage 86, and a rod-end passage 88.

Pump 80 may have variable displacement and be controlled to draw fluid from its associated actuators and discharge the fluid at a specified elevated pressure back to the actuators in two different directions (i.e., pump 80 may be an over-center pump). Pump 80 may include a stroke-adjusting mechanism, for example a swashplate, a position of which is hydro-mechanically adjusted based on, among other things, a desired speed of the actuators to thereby vary an output (e.g., a discharge rate) of pump 80. The displacement of pump 80 may be adjusted from a zero displacement position at which substantially no fluid is discharged from pump 80, to a maximum displacement position in a first direction at which fluid is discharged from pump 80 at a maximum rate into first pump passage 82. Likewise, the displacement of pump 80 may be adjusted from the zero displacement position to a maximum displacement position in a second direction at which fluid is discharged from pump 80 at a maximum rate into second pump passage 84. Pump 80 may be drivably connected to power source 18 of machine 10 by, for example, a countershaft, a belt, or in another suitable manner. Alternatively, pump 80 may be indirectly connected to power source 18 via a torque converter, a gear box, an electrical circuit, or in any other manner known in the art. It is contemplated that pump 80 may be connected to power source 18 in tandem (e.g., via the same shaft) or in parallel (e.g., via a gear train) with other pumps (not shown) of machine 10, as desired.

Pump 80 may also be selectively operated as a motor. More specifically, when an associated actuator is operating in an overrunning condition (i.e., a condition where the actuator is driven by a load to move faster than normally possible when driven by pump 80), the fluid discharged from the actuator may have a pressure elevated above an output pressure of pump 80. In this situation, the elevated pressure of the actuator fluid directed back through pump 80 may function to drive pump 80 to rotate with or without assistance from power source 18. Under some circumstances, pump 80 may even be capable of imparting energy to power source 18, thereby improving an efficiency and/or capacity of power source 18.

It will be appreciated by those of skill in the art that the respective rates of fluid flow into and out of the hydraulic actuator (if embodied as a linear actuator) during extension and retraction may not be equal. That is, because of the location of rod portion 50A within second chamber 54, piston assembly 50 may have a reduced pressure area within second chamber 54, as compared with a pressure area within first chamber 52. Accordingly, during retraction of the hydraulic actuator, more hydraulic fluid may be forced out of first chamber 52 than can be consumed by second chamber 54 and, during extension, more hydraulic fluid may be consumed by first chamber 52 than is forced out of second chamber 54. In order to accommodate the excess fluid discharged during retraction and the additional fluid required during extension, primary circuit 74 may be provided with two makeup valves 90 and two relief valves 92 that connect first and second pump passages 82, 84 to charge circuit 76 via a common passage 94.

Makeup valves 90 may be variable position valves that are disposed within discharge passages 95, between common passage 94 and one of first and second pump passages 82, 84, and configured to selectively allow pressurized fluid from charge circuit 76 to enter first and second pump passages 82, 84. In particular, each of makeup valves 90 may be movable from a first position at which fluid freely flows between common passage 94 and the respective first and second pump passages 82, 84, toward a second position at which fluid from common passage 94 may be blocked from first and second pump passages 82, 84. Each makeup valve 90 may be spring biased toward the second position and only moved toward the first position when a pressure of common passage 94 exceeds the pressure of first and second pump passages 82, 84 by a threshold amount.

Relief valves 92 may be disposed within charge passages 97, between common passage 94 and first and second pump passages 82, 84, and configured to allow fluid relief from primary circuit 74 into charge circuit 76 when a pressure of the fluid exceeds a set threshold of relief valves 92. Relief valves 92 may be set to operate at relatively high pressure levels in order to prevent damage to hydraulic system 72, for example at levels that may only be reached when the linear actuators of machine 10 reach an end-of-stroke position and the flow from pump 80 is nonzero, or during a failure condition of hydraulic system 72.

Charge circuit 76 may include at least one hydraulic source fluidly connected to common passage 94 described above. In the disclosed embodiment, charge circuit 64 has two sources, including a charge pump 96 and an accumulator 98, which may be fluidly connected to common passage 94 in parallel to provide makeup fluid to primary circuit 74. Charge pump 96 may embody, for example, an engine-driven, fixed- or variable-displacement pump configured to draw fluid from a low-pressure tank 100, pressurize the fluid, and discharge the fluid into common passage 94. Accumulator 98 may embody, for example, a compressed gas, membrane/spring, or bladder type of accumulator configured to accumulate pressurized fluid from and discharge pressurized fluid into common passage 94. Excess hydraulic fluid, either from charge pump 96 or from primary circuit 74 (i.e., from operation of pump 80 and/or the hydraulic actuator(s)) may be directed into either accumulator 98 or into tank 100 by way of a charge relief valve 102 disposed in a return passage 104. Charge relief valve 102 may be movable from a flow-blocking position toward a flow-passing position as a result of elevated fluid pressures within common passage 94 and return passage 104.

In some embodiments, an additional set of valves 106 may be disposed within a bypass passage 108 that connects first and second pump passages 82, 84 to common passage 94. Each of valves 106 may be a spring-biased check valve that is pilot operated such that fluid may be allowed to flow through valves 106 in two directions (e.g., from charge circuit 76 into primary circuit 74 and vice versa). For example, the upper valve 106 shown in FIG. 2 may be associated with first pump passage 82, and a pilot passage 109 may communicate fluid from second pump passage 84 with the upper valve 106. When the fluid within second pump passage 84 generates a force that exceeds the spring bias of the upper valve 106, the upper valve 106 may open. When the upper valve 106 opens, fluid flow direction through the upper valve 106 may be dependent upon the pressure differential between charge circuit 74 and first pump passage 82. In particular, if, when the upper valve 106 opens, the pressure within charge circuit 74 exceeds the pressure within first passage 82, the fluid from charge circuit 74 may flow into first pump passage 82. If however, the pressure within first pump passage 82 exceeds the pressure within charge circuit 74 at the time that the upper valve 106 opens, fluid within first pump passage 82 may flow into charge circuit 74. The same may be true regarding the lower valve 106 shown in FIG. 2.

Valves 106 may allow fluid to flow from primary circuit 74 into charge circuit 76 at a lower pressure than possible via relief valves 92 described above. This may be important during retracting operations of the hydraulic actuator, when more fluid is being discharged from first chamber 52 than consumed by pump 80 and supplied to second chamber 54. That is, the excess fluid from first chamber 52 must be removed from primary circuit 74 and directed into charge circuit 76, but the fluid may not have a pressure sufficiently high to open relief valves 92 (and raising this pressure to open relief valves 92 may be undesired for control and efficiency reasons). Valves 106 may allow for this fluid removal at a lower pressure.

It is contemplated that valves 106 may allow for the elimination of makeup valves 90, if desired. That is, in some configurations, the need for two sets of valves to provide makeup fluid may be low and, accordingly, makeup valves 90 may be unnecessary. Alternatively, pilot passages 109 may be associated with makeup valves 90 such that makeup valves 90 would be capable of allowing fluid flow in two directions. In this situation, valves 106 could be eliminated, if desired. Other ways of allowing low-pressure fluid from primary circuit 74 into charge circuit 76 may also be possible.

Regeneration configuration 78 may include components configured to recirculate fluid from the hydraulic actuator directly back into the hydraulic actuator without the fluid passing through pump 80. In particular, regeneration configuration 78 may include a regeneration valve 110 disposed within second pump passage 84, and a regeneration passage 112 connected between first pump passage 82 and regeneration valve 110. Regeneration valve 110 may be a three-way valve that is movable between a first position (shown in FIG. 2) at which fluid may be allowed to flow between pump 80 and second chamber 54 via second pump passage 84 in an unrestricted manner, and a second position at which second pump passage 84 may be substantially isolated or blocked from second chamber 54. When regeneration valve 110 is in the first position, fluid flow from rod-end passage 88 through regeneration passage 112 to head-end passage 86 may be substantially blocked. When regeneration valve 110 is in the second position, fluid may be allowed to flow from (i.e., be pushed out of) second chamber 54 through rod-end and regeneration passages 88,112 and into first chamber 52 via head-end passage 86. Regeneration valve 110 may be spring-biased toward the first position and solenoid operated to move from the first position toward the second position.

During operation of machine 10, the operator may utilize interface device 46 to provide a signal that identifies a desired movement of the various linear and/or rotary actuators to a controller 140. Based upon one or more signals, including the signal from interface device 46 and, for example, signals from various pressure sensors (not shown) and/or position sensors (not shown) located throughout hydraulic system 72, controller 140 may command movement of the different valves and/or displacement changes of the different pumps and motors to advance a particular one or more of the linear and/or rotary actuators to a desired position in a desired manner (i.e., at a desired speed and/or with a desired force).

Controller 140 may embody a single microprocessor or multiple microprocessors that include components for controlling operations of hydraulic system 72 based on input from an operator of machine 10 and based on sensed or other known operational parameters. Numerous commercially available microprocessors can be configured to perform the functions of controller 140. It should be appreciated that controller 140 could readily be embodied in a general machine microprocessor capable of controlling numerous machine functions. Controller 140 may include a memory, a secondary storage device, a processor, and any other components for running an application. Various other circuits may be associated with controller 140 such as power supply circuitry, signal conditioning circuitry, solenoid driver circuitry, and other types of circuitry.

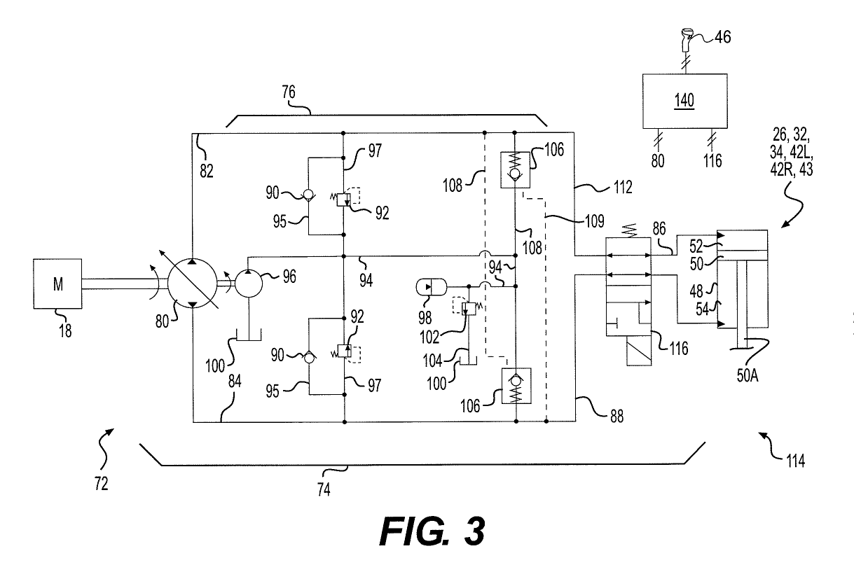

FIG. 3 illustrates an alternative embodiment of hydraulic system 72. Like hydraulic system 72 of FIG. 2, hydraulic system 72 of FIG. 3 may include the hydraulic actuator connected to pump 80 in a closed-loop manner via first and second pump passages 82, 84 and head- and rod-end passages 86, 88 of primary circuit 74. Hydraulic system 72 of FIG. 3 may also include charge circuit 76. In contrast to the embodiment of FIG. 2, however, hydraulic system 72 of FIG. 3 may include a different regeneration configuration 114. Regeneration configuration 114 may include a two-position, four-way regeneration valve 116 disposed within both of first and second pump passages 82, 84, and regeneration passage 112 (referring to FIG. 2) may be omitted. In this configuration, regeneration valve 116 may be configured to move from a first position (shown in FIG. 2) at which fluid may be allowed to flow between pump 80 and first and second chambers 52, 54 via first and second pump passages 82, 84, respectively, in an unrestricted manner, to a second position at which second pump passage 84 may be substantially isolated or blocked from second chamber 54. When regeneration valve 116 is in the second position, rod-end passage 88 may be fluidly communicated with head-end passage 86 via regeneration valve 116.

### INDUSTRIAL APPLICABILITY

The disclosed hydraulic system may be applicable to any machine where improved hydraulic efficiency is desired. The disclosed hydraulic system may provide for improved efficiency through the selective use of closed-loop technology, open-loop technology, and fluid regeneration. Operation of hydraulic system 72 will now be described.

During operation of machine 10, an operator located within station 20 may command a particular motion of work tool 14 in a desired direction and at a desired velocity by way of interface device 46. One or more corresponding signals generated by interface device 46 may be provided to controller 140 indicative of the desired motion, along with machine performance information, for example sensor data such a pressure data, position data, speed data, pump or motor displacement data, and other data known in the art.

In response to the signals from interface device 46 and based on the machine performance information, controller 140 may generate control signals directed to the stroke-adjusting mechanism of pump 80. For example, to drive the hydraulic actuator depicted in FIG. 2 at an increasing speed in an extending direction, controller 140 may generate a control signal that causes pump 80 of primary circuit 74 to increase its displacement in the first direction that results in pressurized fluid discharge into first pump passage 82, head-end passage 86, and first chamber 52 at a greater rate. When fluid from pump 80 is directed into first chamber 52, return fluid from second chamber 54 of the hydraulic actuator and/or from the other linear or rotary actuators of hydraulic system 72 may flow through rod-end passage 88 and second pump passage 84 back into pump 80 in closed-loop manner. Regeneration valve 110 (or 116, referring to FIG. 3) may be in its first position during normal extensions. At this time, because more fluid may be consumed by first chamber 52 than discharged by second chamber 54, makeup fluid from charge circuit 76 (e.g., from charge pump 96 and/or accumulator 98) may be directed into second pump passage 84 via common passage 94 and makeup valves 90 and/or valves 106.

Similarly, to drive the hydraulic actuator at an increasing speed in a retracting direction, controller 140 may generate a control signal that causes pump 80 of primary circuit 74 to increase its displacement in the second direction that results in pressurized fluid discharge into second pump passage 84, rod-end passage 88, and second chamber 54 at a greater rate. When fluid from pump 80 is directed into second chamber 54, return fluid from first chamber 52 of the hydraulic actuator and/or from the other linear or rotary actuators of hydraulic system 72 may flow through head-end passage 86 and first pump passage 82 back into pump 80 in closed-loop manner. Regeneration valve 110 (or 116, referring to FIG. 3) may be in its first position during normal retractions. At this time, because more fluid may be discharged by first chamber 52 than consumed by second chamber 54, the excess fluid from first chamber 52 may be directed into charge circuit 76 (e.g., into accumulator 98 and/or into tank 100) via common passage 94 and relief valves 92 (if the pressure is high enough) or valves 106 and 102 (if the pressure is lower).

In some applications, it may be desirable to move the hydraulic actuator faster than normally possible when the hydraulic actuator is provided with fluid from only pump 80 (i.e., faster than possible in a permanently closed-loop circuit). In this situation, fluid from the discharging chamber of the hydraulic actuator may be recirculated directly back into the filling chamber of the hydraulic actuator via regeneration configuration 78 (or 114, referring to FIG. 3), without the fluid passing through pump 80. In particular, regeneration valve 110 (or 116, referring to FIG. 3) may be moved from its first position to its second position to increase the amount of fluid supplied to the filling chamber. For example, when regeneration valve 110 is moved to the second position during extension of the hydraulic actuator, the fluid discharging from second chamber 54 may be directed through rod-end passage 88 and regeneration valve 110 to join with fluid from pump 80 entering head-end passage 86, thereby increasing the flow rate of fluid into first chamber 52. This increased flow rate of fluid into first chamber 52 may result in a higher-speed extension of the hydraulic actuator.

At this time, because second pump passage 84 may be substantially isolated from rod-end passage 88 via regeneration valve 110, primary circuit 74 may be temporarily changed from a closed-loop circuit to an open-loop circuit. That is, pump 80 may draw in fluid from only charge circuit 76 (i.e., not from the hydraulic actuator) via common passage 94, makeup valve 90 and/or valve 106, and second pump passage 84, and discharge all of its fluid into first pump passage 82 for consumption by the hydraulic actuator.

In other applications, it may be possible for fluid discharging from the hydraulic actuator to have a pressure greater than a discharge pressure of pump 80. In these situations, energy from the highly-pressurized fluid may be recuperated in a number of different ways. First, because primary circuit 74 may normally operate in a closed-loop manner, the highly-pressurized fluid may be directed back through pump 80 to drive pump 80 as a motor, thereby returning energy to power source 18. Second, the highly-pressurized fluid may be directed into accumulator 98 valves 106 and common passage 94, thereby storing the energy for future use. Third, regeneration valve 110 may allow for high-pressure fluid being discharged from first chamber 52 (e.g., when work tool 14 is under load and the hydraulic actuator is retracting) to be redirected into second chamber 54 via regeneration valve 114. During regeneration of fluid from first chamber 52 to second chamber 54, approximately one half of the discharging flow may be directed into second chamber 54, while the remaining half of the flow may pass back to pump 80 via first pump passage 82, resulting in less viscous loss in first pump passage 82.

Because hydraulic system 72 may be selectively operated as a closed-loop system during normal operations and as an open-loop system during regeneration, hydraulic system 72 may provide benefits associated with both types of systems. In particular, hydraulic system 72 may have high efficiency associated with closed-loop operation, yet still have high performance associated with open-loop operation during regeneration. In addition, hydraulic system 72 may provide this functionality in a simple, low-cost configuration.

It will be apparent to those skilled in the art that various modifications and variations can be made to the disclosed hydraulic system. Other embodiments will be apparent to those skilled in the art from consideration of the specification and practice of the disclosed hydraulic system. It is intended that the specification and examples be considered as exemplary only, with a true scope being indicated by the following claims and their equivalents.

What is claimed is:

1. A hydraulic system, comprising:
a pump;
a hydraulic actuator having a first chamber and a second chamber;
a first pump passage fluidly communicating the pump with the first chamber;
a second pump passage connected to the pump; and
a regeneration valve movable from a first position at which the second pump passage is connected to the second chamber and the second chamber is isolated from the first chamber, to a second position at which the second pump passage is blocked and the second chamber is connected to the first chamber.

2. The hydraulic system of claim 1, wherein:
the pump is connected to the hydraulic actuator in a closed-loop manner when the regeneration valve is in the first position; and
the pump is connected to the hydraulic actuator in an open-loop manner when the regeneration valve is in the second position.

3. The hydraulic system of claim 1, wherein the pump has variable-displacement and over-center functionality.

4. The hydraulic system of claim 1, wherein the regeneration valve is solenoid operated, and spring-biased toward the first position.

5. The hydraulic system of claim 4, wherein the first pump passage fluidly communicates the pump with the hydraulic actuator via the regeneration valve.

6. The hydraulic system of claim 4, wherein the first pump passage bypasses the regeneration valve.

7. The hydraulic system of claim 4, wherein the regeneration valve is a two-position, four-way valve.

8. The hydraulic system of claim 4, wherein the regeneration valve is a two-position, three-way valve.

9. The hydraulic system of claim 1, further including:
an accumulator;
a common passage connected to the accumulator
charge passages fluidly connecting each of the first and second pump passages with the common passage;
first and second relief valves disposed within the charge passages;
discharge passages fluidly connecting the common passage with the first and second pump passages; and
first and second check valves disposed within the discharge passages.

10. The hydraulic system of claim 9, further including:
a low-pressure tank; and
a charge pump configured to draw fluid from the low-pressure tank and discharge fluid into the common passage.

11. The hydraulic system of claim 9, further including a charge relief valve connecting the common passage to the low-pressure tank.

12. The hydraulic system of claim 9, wherein the charge and discharge passages are fluidly communicated with each other.

13. The hydraulic system of claim 12, further including:
a bypass passage disposed between the first and second pump passages and the common passage;
a third check valve disposed within the bypass passage between the first pump passage and the common passage; and
a fourth check valve disposed within the bypass passage between the second pump passage and the common passage.

14. The hydraulic system of claim 13, further including:
a first pilot passage fluidly communicating the second pump passage with the first check valve; and
a second pilot passage fluidly communicating the first pump passage with the second check valve.

15. A hydraulic system, comprising:
a pump having variable-displacement and over-center functionality;
a hydraulic cylinder having a head-end chamber and a rod-end chamber;
a first pump passage fluidly communicating the pump with the head-end chamber;
a second pump passage connected to the pump;
a regeneration valve movable from a first position at which the second pump passage is connected to the rod-end chamber and the rod-end chamber is isolated from the head-end chamber, and a second position at which the second pump passage is blocked and the rod-end chamber is connected to the head-end chamber;
an accumulator;
a common passage connected to the accumulator
charge passages fluidly connecting the first and second charge passages with the common passage;
first and second relief valves disposed within the charge passages;
discharge passages fluidly connecting the common passage with the first and second pump passages;
first and second check valves disposed within the discharge passages;
a low-pressure tank; and
a charge pump configured to draw fluid from the low-pressure tank and discharge fluid into the common passage.

16. A method of operating a hydraulic system, comprising:
pressurizing fluid with a pump;
maintaining fluid communication between the pump and a head-end chamber of a hydraulic cylinder;
selectively fluidly communicating the pump with a rod-end chamber of the hydraulic cylinder during retraction of the hydraulic cylinder and isolating the pump from the rod-end chamber via a regeneration valve during extension of the hydraulic cylinder; and
when the pump is isolated from the rod-end chamber of the hydraulic cylinder, fluidly connecting the rod-end chamber to the head-end chamber via the regeneration valve.

17. The method of claim 16, further including:
adjusting a displacement of the pump to control a speed of the hydraulic cylinder; and
adjusting an output direction of the pump to control a movement direction of the hydraulic cylinder.

18. The method of claim 16, further including:
accumulating pressurized fluid discharged from hydraulic cylinder; and
supplying accumulated fluid to the pump when the pump is isolated from the rod-end chamber of the hydraulic cylinder.

19. The method of claim 18, wherein:
the pump is a primary pump; and
the method further includes supplying pressurized fluid from a charge pump to the primary pump when the primary pump is isolated from the rod-end chamber of the hydraulic cylinder.

20. The method of claim 19, further including accumulating pressurized fluid from the charge pump.
